(19) United States
(12) Patent Application Publication
(10) Pub. No.: US 2008/0047481 A1
(43) Pub. Date: Feb. 28, 2008

(54) AMPHIBIOUS VEHICLE

(76) Inventors: Nicolaas Maarschalkerweerd, Mt. Brydges (CA); Vivian Dall'Armi, London (CA)

Correspondence Address: CARLSON, GASKEY & OLDS, P.C., 400 WEST MAPLE ROAD, SUITE 350, BIRMINGHAM, MI, 48009, US

(21) Appl. No.: 11/842,222

(22) Filed: Aug. 21, 2007

Related U.S. Application Data
(60) Provisional application No. 60/839,810, filed on Aug. 24, 2006.

(51) Int. Cl. B60F 3/00

(52) U.S. Cl. 114/344

(57) ABSTRACT

A disclosed amphibious vehicle includes a trailer portion, a hull including a bottom, and at least one wheel. The wheel moves between a first wheel position where at least some of the wheel is below the hull bottom, and a second wheel position above the hull bottom. The wheel supports the trailer portion when in the first wheel position and the hull bottom supports the trailer when the wheel is in the second wheel position. One example includes a tongue fitted with a coupler for towing the trailer portion that moves between a first tongue position and a second tongue position further from the hull than the first tongue position.

### CROSS REFERENCE TO RELATED APPLICATIONS

The application claims priority to U.S. Provisional Application No. 60/839,810, which was filed on 24 Aug. 2006.

### BACKGROUND OF THE INVENTION

The application relates generally to a vehicle for transporting cargo across land and water.

Known trailers transport cargo on land, but are limited to land-based movements. The trailers include any number or arrangement of axles and wheels to facilitate movement. Trailers are not self-propelled, and instead include a tongue for attaching the trailer to another vehicle, such as, but not limited to, a truck or all-terrain-vehicle (ATV). Moving the vehicle tows the trailer with the cargo.

Known boats transport cargo across water, but are limited to water-based movements.

Transporting the same cargo across land and water is often complicated as a separate boat and trailer must be used. As an example, a person constructing a cottage in a location accessible only by water must load construction material into a boat, drive the boat across water to a position near the desired location, unload the construction material, and then transport the construction material to the construction site using a trailer.

Transporting boats over land is similarly difficult. Although some boats are small enough to be moved across land by hand, many others must be loaded on a boat trailer. Boat operators use boat trailers when moving the boat across land from a river to a lake, for example. Loading the boat is a time consuming process that involves backing a trailer into the river, maneuvering the boat onto the boat trailer, and then securing the boat to the boat trailer. The boat must also be launched from the boat trailer after reaching the lake, which is similarly time consuming.

Transporting the boat using a separate boat trailer also affects boat portability. For example, the boat operator must make sure that both the boat trailer and the boat are in the same general location in order to load the boat on the boat trailer. If the boat operator wishes to move the boat across land after launching the boat, the boat operator must drive the boat back to the same boat trailer location, return to the vehicle to move the boat trailer to another loading location, or utilize another boat trailer.

### SUMMARY OF THE INVENTION

An example amphibious vehicle includes a trailer portion, a hull including a bottom, and at least one wheel. The wheel moves between a first wheel position where at least some of the wheel is below the hull bottom, and a second wheel position above the hull bottom. The wheel supports the trailer portion when in the first wheel position and the hull bottom supports the trailer portion when the wheel is in the second wheel position.

One example includes a tongue for towing the trailer portion. The tongue rotates about an axis near the base of the transom. The tongue rotates between a stowed position and a position for towing.

The example amphibious vehicle includes a trailer portion having a boating configuration and a towing configuration. At least one wheel extends from the trailer portion. The wheel supports the trailer portion in the towing configuration for movement of the trailer portion on land. The trailer includes a hull portion that supports the trailer portion in the boating configuration for movement of the trailer portion on water.

An example method of transporting cargo includes towing cargo across land using a vehicle, retracting a wheel above the hull bottom, and moving the cargo across water using the vehicle.

The example amphibious vehicle can be towed on land by an ATV. If a body of water impedes the movement of both vehicles then the option exists that the ATV can be transported across the water as cargo in the amphibious vehicle

### BRIEF DESCRIPTION OF THE DRAWINGS

These and other features of the disclosed example can be understood from the following specification and drawings, the following of which is a brief description.

FIG. 1 illustrates an example amphibious vehicle in a towing configuration.

FIG. 2 illustrates the FIG. 1 vehicle in a boating configuration.

FIG. 3 illustrates a wheel area of the FIG. 1 vehicle showing a wheel in an extended position below the hull bottom.

FIG. 4 illustrates another view of the wheel area of the FIG. 1 vehicle showing the wheel in a retracted position above the hull bottom.

FIG. 5 illustrates yet another view of the wheel area of the FIG. 1 vehicle showing a sliding door in an open position.

FIG. 6 illustrates yet another view of the wheel area of the FIG. 1 vehicle showing the sliding door in a closed position.

FIG. 7 illustrates a tongue area of the FIG. 1 vehicle showing a partial sectional view of an example tongue in an extended position ready for towing.

FIG. 8 illustrates a side view of the tongue area of the FIG. 1 vehicle showing a partial sectional view of the tongue in a stowed and nearly upright position.

FIG. 9 illustrates a tongue area of the FIG. 1 vehicle showing a partial sectional view of another example tongue in a retracted position.

FIG. 10 illustrates a loading door of the FIG. 1 vehicle in a down position.

### DETAILED DESCRIPTION OF AN EXAMPLE EMBODIMENT

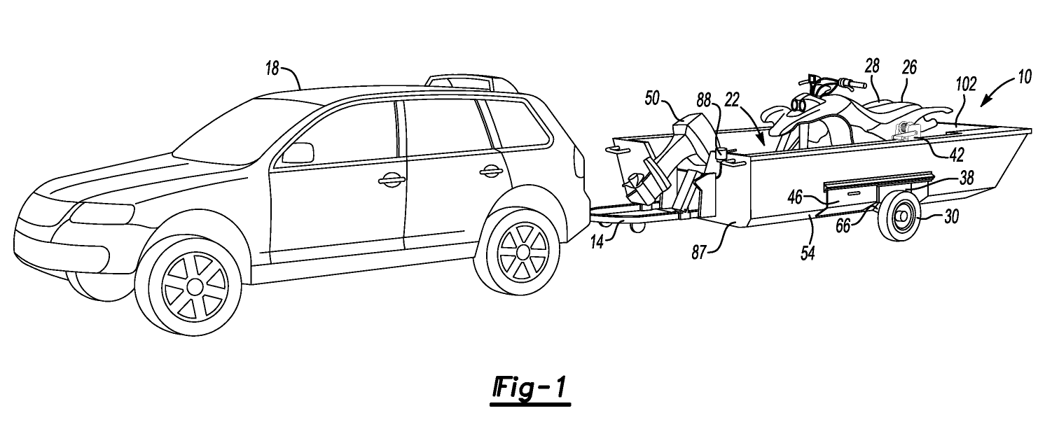

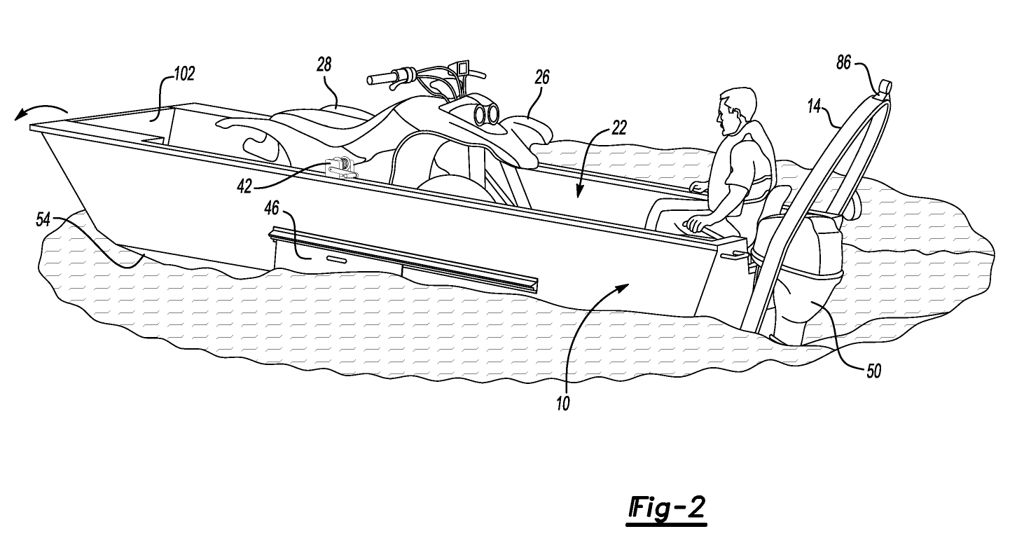

An example amphibious vehicle 10 includes a towing configuration of FIG. 1 and a boating configuration of FIG. 2. The towing configuration includes a tongue 14 and a ball coupler 86 for attaching the vehicle 10 to a vehicle 18, for example a Sport Utility Vehicle (SUV). The vehicle 18 tows the attached vehicle 10 as the vehicle 18 moves. The vehicle 10 includes wheels 30 that support the vehicle 10 when used in a towing mode.

The vehicle 10 changes from the towing configuration to the boating configuration to move through water. A water tight hull 54 on the underside of the vehicle 10 displaces an appropriate amount of water to maintain the buoyancy of the vehicle 10 within water. An outboard motor 50 propels the vehicle 10 when in the boating configuration.

A cargo area 22 transports cargo 26 when the vehicle 10 is in the towing configuration or the boating configuration. Example cargo 26 includes an All Terrain Vehicle (ATV) 28, which is another type of vehicle suitable for towing the vehicle 10.

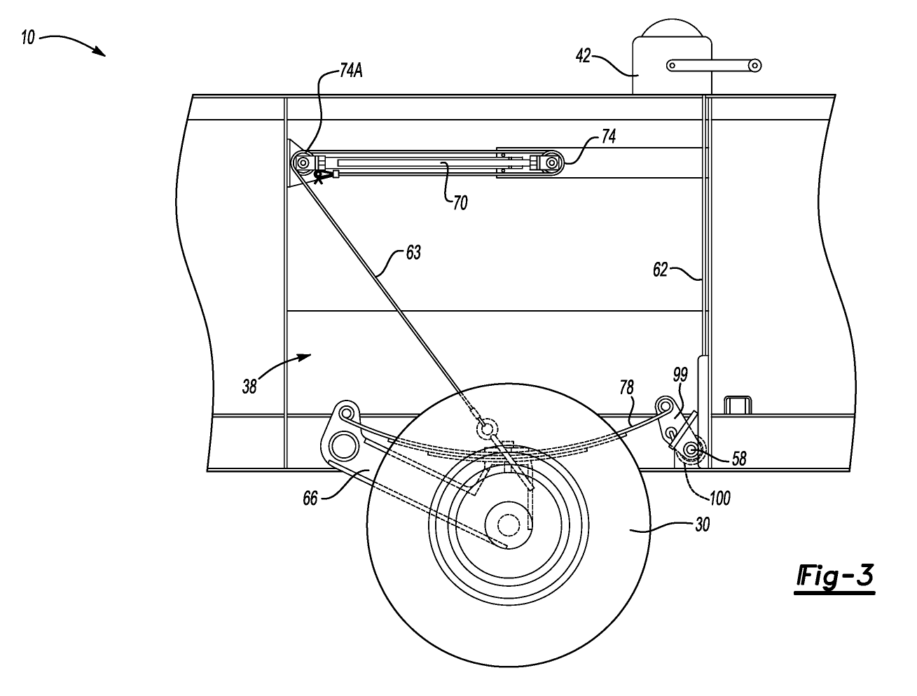

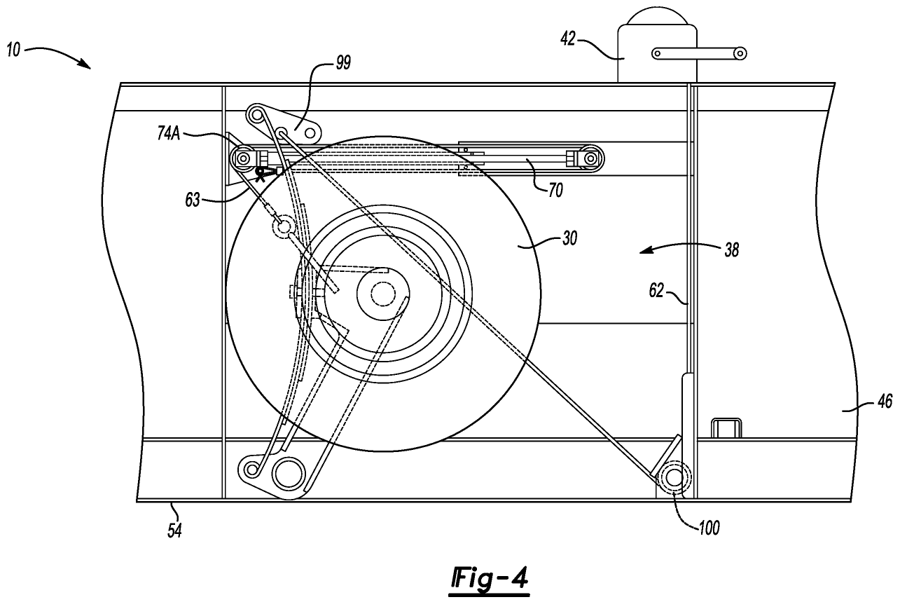

The tongue 14 and the wheels 30 are moveable between an extended position for towing and a retracted position for boating. FIGS. 3 and 4 illustrate an example system for retracting and extending one of the wheels 30 of the vehicle 10. An auto braking hand winch 42, coupled with a gas spring actuator 70, and at least one cable 62 move the wheels 30 between the extended and retracted positions. The wheels 30 retract at least partially into a wheel well 38 when in the retracted position. In this example, each wheel 30 is completely received into a corresponding wheel well 38.

The wheel 30 can be moved from an extended position to a retracted position, when the hull 54 is supported by either the wheel 30 or a buoyancy force caused by water on the hull 54. To retract the wheel 30, the operator rotates a handle on the hand winch 42 in a first direction, which increases tension on the cable 62. Other examples may include a hydraulic ram or hydraulic ram coupled with a cable and pulley assembly and a hydraulic power pack in place of the hand winch 42. Slack in cable 62 is taken up by the cable 62 winding on the cable drum of winch 42. The cable to spring link bracket 99 contacts a stop on the pulley bracket 100, which prevents further rotation of the handle on the hand winch 42.

Tension in the cable 62 overcomes forces caused by the weight of the hull 54 on the wheel 30 and force from the gas spring cable 63 on the support arm 66. Accordingly, the operator is able to remove a system locking member 58, such as a pin, enabling raising movements of the wheel 30. The operator then rotates the handle on the hand winch 42 in a second direction, which releases the cable 62 providing slack in the system and enabling the gas spring actuator 70 to extend. The gas spring actuator 70 is biased toward an extended position. Other examples may include a spirally wound spring or other spring loaded device in place of the gas spring actuator 70.

A second cable 63 loops over pulleys 74, 74A attached to the gas spring actuator 70. The gas spring actuator 70 moves the pulley 74 as it extends, which pulls the second cable 63. Pulling the second cable 63 rotates the support arm 66 and one of the attached wheels 30 upward into the corresponding wheel well 38. In this example, the gas spring actuator 70 movement maintains about a 1:2 ratio relative to the amount of wheel 30 retraction. The wheels 30 only move as slack in the cable 62 is made available. Thus, the operator controls the speed of the movement by controlling the speed of rotation of the handle on the hand winch 42. Sliding doors 46 are slidable over the wheel well 38 after retracting the wheel 30 into the wheel well 38.

To move back to an extended position, an operator opens the sliding doors 46 on the sides of the vehicle 10. The operator then rotates the handle on the hand winch 42 in the first direction, opposite the second direction, to overcome the biasing force exerted by the gas spring actuator 70 and any forces caused by the wheel 30 contacting the earth which will in turn raise the hull 54. The operator will hit a hard stop once the cable to spring link bracket 99 contacts the pulley bracket 100. Once the hard stop has been contacted the operator will no longer be able to rotate the handle on the hand winch 42 in the first direction. The operator then replaces the locking member 58, this allows the operator to give some slack in the cable 62 while the locking member 58 maintains the position of the wheels 30. Support arm 66 rotates as the wheel 30 lowers.

A leaf spring 78 forms a portion of the suspension system when the wheels 30 are in the extended position. The leaf spring 78 enhances the towing performance of the vehicle 10 when used in the trailer configuration.

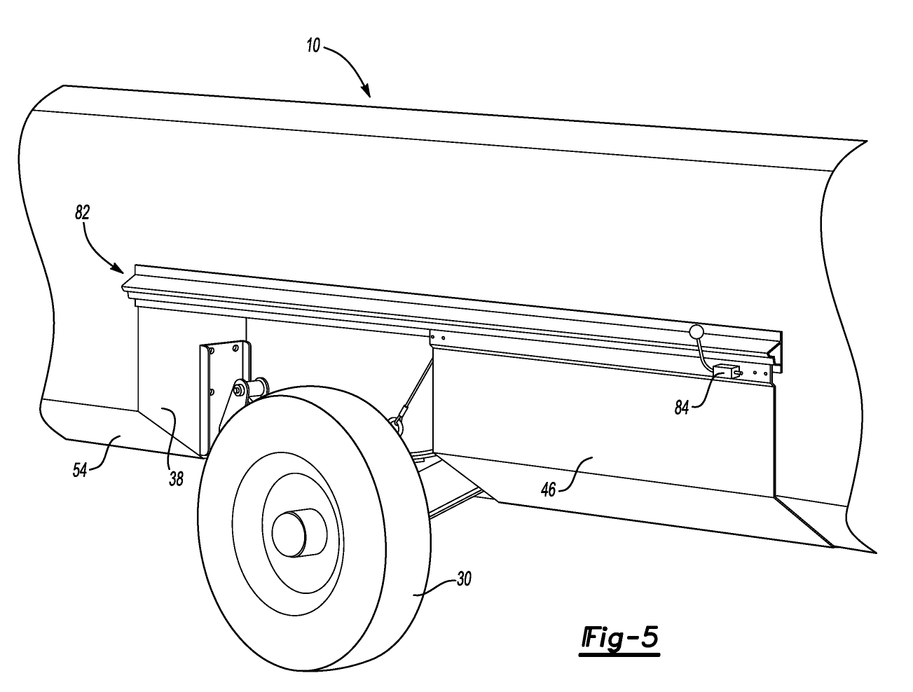

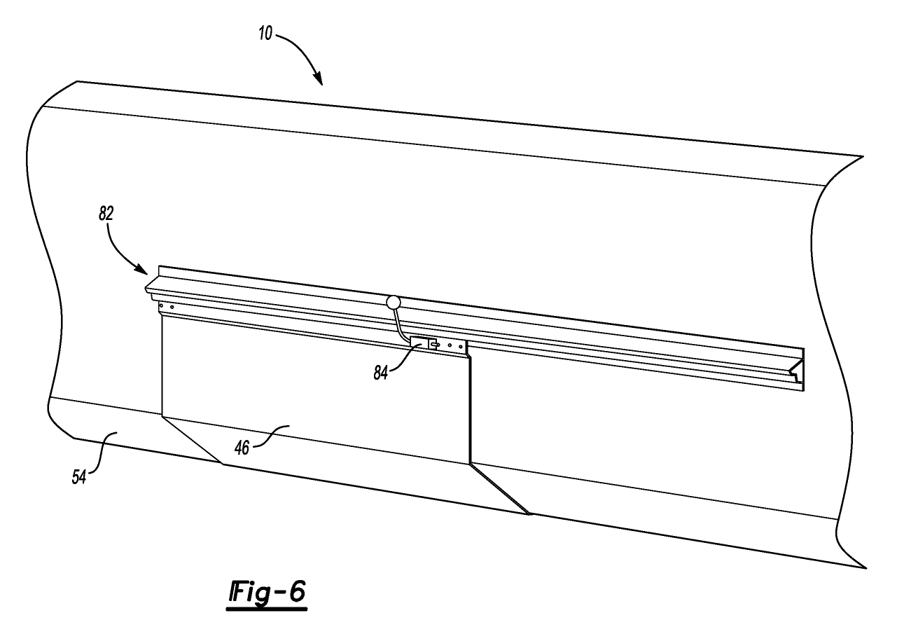

In the illustrated example boating configuration, the wheels 30 retract fully into the wheel wells 38 enabling a sliding door 46 to close and to cover each wheel well 38. The sliding door 46 moves along a pair of extruded channels 82 on the hull 54, as shown in FIGS. 5 and 6. A handle and latch assembly 84, such as a spring loaded latch assembly, hold the sliding door 46 in position. The closed sliding doors 46 act as a portion of the hull 54 preventing drag by deflecting water from the wheel well 38. Fully retracting the wheels 30 into the wheel wells 38 allows the sliding doors 46 to close. Although the sliding doors 46 seal the wheel wells 38 from water in some examples, there is no need for the sliding doors 46 to fully prevent water from entering the wheel wells 38 as the interior of the wheel wells 38 is configured to be waterproof so that water does not enter the cargo area 22. Instead, the sliding door 46 need only lessen the drag of water on the wheel well 38.

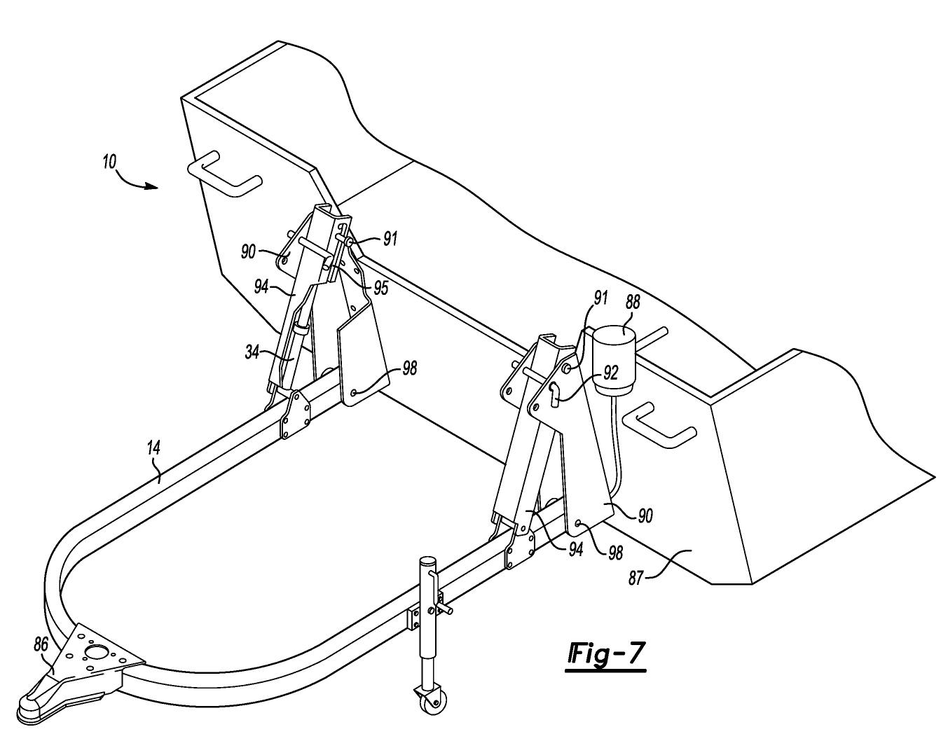

The example vehicle 10 includes additional features for changing between the towing configuration and the boating configuration. For example, as shown in FIG. 7, the ball coupler 86 on the tongue 14 provides an attachment for coupling the vehicle 10 to a vehicle 18 (FIG. 1). A set of brackets 90 provide support for the tongue 14, braces 94, and a pair of hydraulic cylinders 34. Bolts 91 secure the hydraulic cylinders 34 to the brackets 90. Pressurizing extends the hydraulic cylinders 34 to rotate the tongue 14 away from the transom 87 to the towing position shown. The position of the braces 94 relative to the bolts 91 is adjustable within notches of a slot 95 in the braces 94. The slots 95 in braces 94 have notches for accommodating the bolts 91 in at least one position. Adjusting the position of the braces 94 relative the brackets 90 changes the degree of rotation of the tongue 14 relative to the transom which in turn facilitates placing the ball receiver 86 at an appropriate height for towing.

In this example, pins 92 inserted through holes in the brackets 90 contact the braces 94 locking the bolt 91 in a notch in a slot 95 of brace 94 which in turn locks the tongue 14 in the towing position. The brackets 90, the braces 94, or both may include additional holes for locking the tongue 14 in other positions, such as positions that locate the coupler 86 at different heights relative to ground level to accommodate differing tow vehicle 18 ball heights.

To move the tongue 14 from the trailer configuration to the boating configuration, the operator backs the vehicle 10 into a body of water. The buoyancy of the water raises portions of the vehicle 10, which increases the load exerted downward through the coupler 86 and lessens load on the wheels 30. At a certain point, the water and the coupler 86 may share the entire load of the vehicle 10. The proportion of which vehicle 10 is supported by the coupler 86, wheels 30 and water depends on several factors, some of which include the angle of the ground as vehicle 18 and vehicle 10 enter the water, height of hitch on vehicle 18, and the distribution and weight of cargo 26 in vehicle 10.

The load of the vehicle 10 exerted on the hitch of the vehicle 18 through the coupler 86 will often inhibit manually decoupling the coupler 86 from the vehicle 18. With the pins 92 removed, the operator releases hydraulic pressure inside the cylinders 34 using a manually controllable valve located on a hydraulic pumping unit 88. The escaping hydraulic fluid allows the cylinders 34 to retract, which facilitates controlled rotation of the tongue 14 about a pivot point 98 until the transom 87 hull area of vehicle 10 is supported by either buoyancy of the transom 87 hull area of vehicle 10 or the ground while the rest of the vehicle 10 weight is supported by any combination of wheels 30 and buoyancy of the forward area of the hull 54. At that point, the load from the vehicle 10 on the coupler 86 is only that of the weight of the tongue 14, brackets 94 and hydraulic cylinder rods 34.

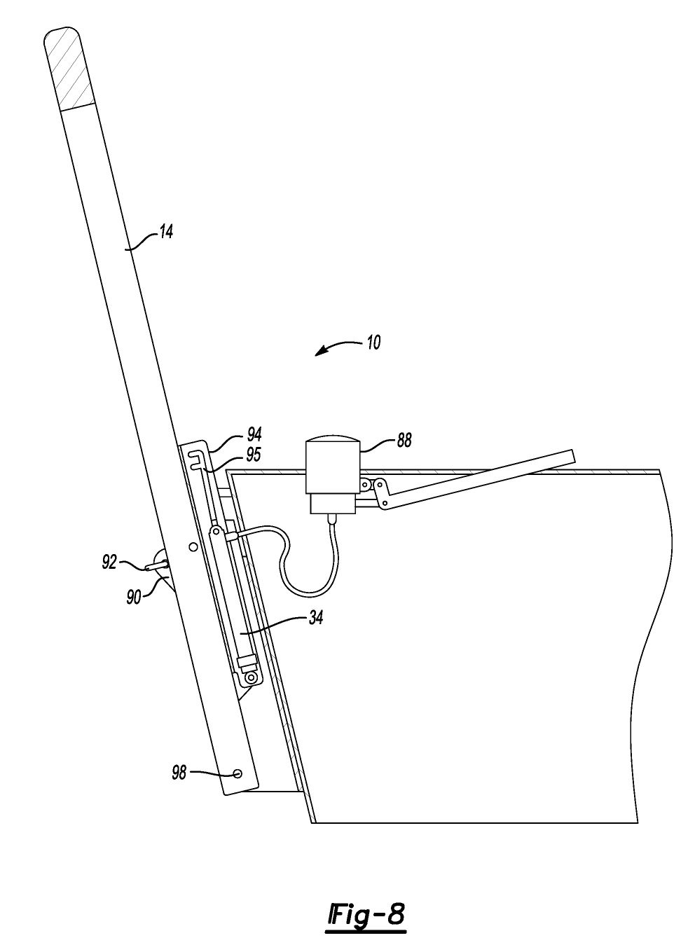

The operator then manually decouples the coupler 86 from the vehicle 18 and by lifting tongue 14 causes the tongue 14 to rotate towards the transom 87 of the vehicle 10. The bolts 91 guide the respective braces 94 through the slots 95 as the tongue 14 rotates toward a stowed position. A locking pin 92 holds the tongue 14 in the stowed position near the vehicle 10. In the tow or stowed position, the cylinders 34 nest between respective braces 94, as shown in FIG. 8. In addition to decoupling the vehicle 10 from the vehicle 18, raising or retracting the tongue 14 results in less drag when operating the vehicle 10 in the boating configuration.

The wheels 30, which may or may not support a portion of the load of vehicle 10, can be moved by the operator to a retracted position, which will in turn allow the water under vehicle 10 to support the load of vehicle 10 instead of the wheels 30. The operator can also now close the sliding doors 46 in preparation for boating. The vehicle 10 can be decoupled from the vehicle 18 on land using a tongue jack, for example. Vehicle 10 may also be lowered to the ground on land while coupled to vehicle 18 in a similar fashion as described above. The operator is free to move the wheels 30 and the hitch 14 between retracted and extended positions at any time. For example, when on land, the operator may store the vehicle 10 so that it rests on the hull 54 instead of the wheels 30.

To couple the vehicle 10 to the vehicle 18, such as when moving the vehicle 10 from the boating configuration to the towing configuration, the operator removes the locking pin 92 and rotates the tongue 14 away from the transom 87 toward a horizontal position. The tongue 14 pivots about a pivot axis 98 located near the bottom of the transom 87 when moving between the stowed and tow position. Once the operator manually couples the coupler 86 to the hitch on vehicle 18 the operator must then pressurize the cylinders 34 using the hydraulic hand pump 88. Pressurizing the cylinders 34 extends the cylinders 34, which forces the tongue 14 to rotate towards the tow position. The degree of rotation of the tongue 14 is limited by the slots 95 in braces 94. Once the edges of the slots 95 contact the bolt 91, the tongue 14 cannot rotate any further away from the transom 87. At this point, holes in brackets 90 and braces 94 will be aligned allowing pin 92 to be inserted, locking the location of the brace 94 and therefore the angle of the tongue 14 to the brackets 90 in a position suitable for towing. In another example, the operator uses an electric pump to extend the hydraulic cylinders 34. In such a position, the coupler 86 exerts some downward force on the vehicle 18.

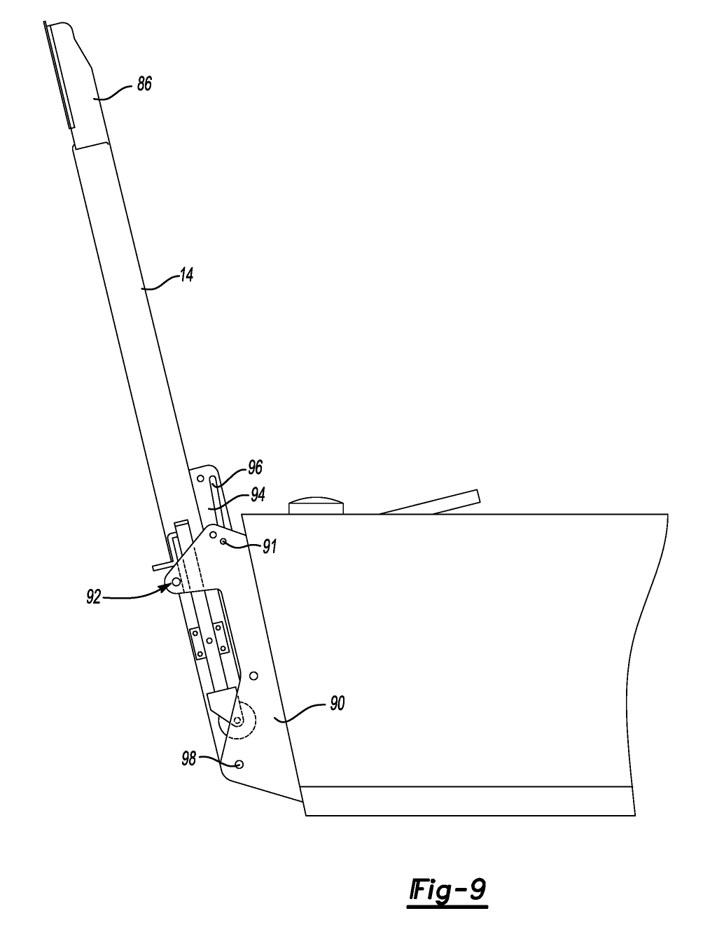

In the example tongue 14 of FIG. 9, the towing height of the coupler 86 does not adjust, as the slot 96 does not include notches as in the FIG. 7 example. In both examples, the pin 92 prevents rotation of the tongue 14 from the extended position.

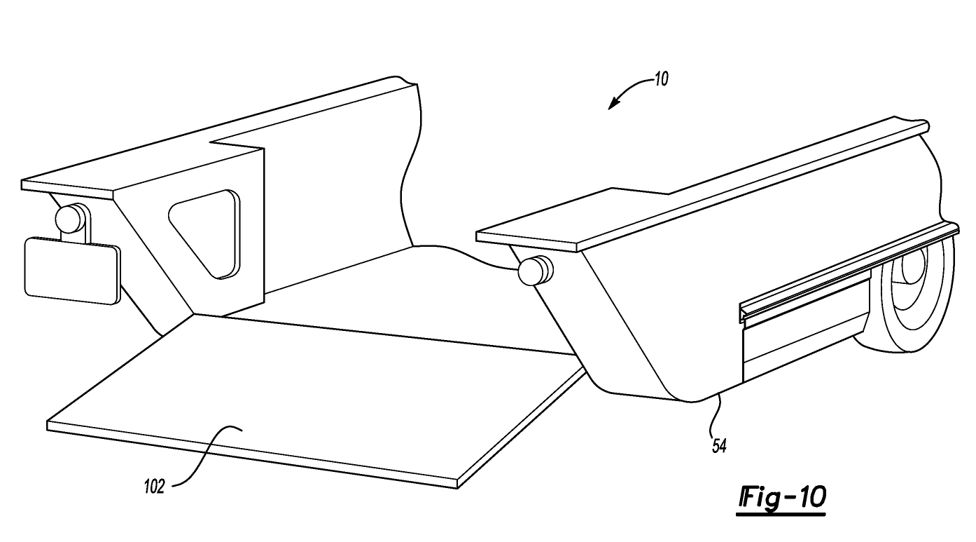

Referring now to FIGS. 10 and 2, the example vehicle 10 in the boating configuration is loaded with cargo 26. The example embodiment includes a hinged door 102 forming one of the sides of the vehicle 10. The door 102 rotates away from the vehicle 10 to provide an unloading point for the cargo 26. After directing the vehicle 10 in the boating configuration to an unloading location, such as shallow water or a sandy beach, the operator rotates the door 102 away from the vehicle 10 to provide a ramp-like area for cargo 26 and passengers exiting the vehicle 10, as shown in FIG. 10. For example, driving the ATV 28 off of the vehicle 10 to a land location when the door 102 is rotated away from the vehicle 10.

After unloading the ATV 28, the operator could use the ATV 28 to tow the vehicle 10 to another location. To do so, the operator turns the vehicle 10 in the water so that the tongue 14 is facing the land. The operator removes the pins 92 and then rotates the tongue 14 so that the coupler 86 couples the ball on the ATV 28. In this motion the hydraulic cylinders 34 are free to extend as the operator rotates the tongue 14 away from the transom 87. The tongue 14 may or may not be in the tow position at this time. If the tongue 14 is not in the tow position the operator then pressurizes the hydraulic cylinders 34 using the pump 88 (FIG. 8), to extend the hydraulic cylinders 34 and move the tongue 14 to the tow position causing the ATV 28 to support a portion of the vehicle 10. Such action usually also raises the transom 87 of the vehicle 10 out of the water. Once the hydraulic cylinders 34 have been appropriately extended, the pins 92 can be reinserted into the braces 90 ensuring that the tongue 14 remains in a fixed position when towed. With the vehicle 10 transformed to a trailer configuration, the operator drives the ATV 28 to another land location with the vehicle 10 in tow.

Although a preferred embodiment of this invention has been disclosed, a worker of ordinary skill in this art would recognize that certain modifications would come within the scope of this invention. For that reason, the following claims should be studied to determine the true scope and content of this invention.

1. An amphibious vehicle, comprising:
a trailer portion;
a hull including a bottom; and
at least one wheel moveable between a first wheel position in which at least some of the wheel is below said hull bottom and a second wheel position above said hull bottom, said at least one wheel supporting said trailer portion when in said first wheel position and said hull bottom supporting said trailer portion when said at least one wheel is in said second wheel position.

2. The amphibious vehicle of claim 1, wherein said at least one wheel is entirely above said hull bottom when in said second wheel position.

3. The amphibious vehicle of claim 1, including a wheel well, said at least one wheel being retracted within said wheel well when in said second wheel position.

4. The amphibious vehicle of claim 3, including a door for covering said wheel well when said at least one wheel is in said second wheel position.

5. The amphibious vehicle of claim 1, wherein said at least one wheel is biased toward said second wheel position.

6. The amphibious vehicle of claim 5, including a hydraulic cylinder for biasing said at least one wheel into said second wheel position.

7. The amphibious vehicle of claim 5, including a charged gas cylinder for moving said at least one wheel into said second wheel position

8. The amphibious vehicle of claim 1, including a locking member for holding said at least one wheel in said first wheel position.

9. The amphibious vehicle of claim 1, including at least one cable for moving said at least one wheel between said first wheel position and said second wheel position.

10. The amphibious vehicle of claim 1, including a tongue configured for attachment to another vehicle, said tongue is rotatable between a first tongue position and a second tongue position further from said hull than said first tongue position.

11. The amphibious vehicle of claim 10, wherein said vehicle is towable when said wheel is in said first wheel position and said tongue is in said second tongue position.

12. The amphibious vehicle of claim 10, including at least one hydraulic cylinder for moving said tongue between said first tongue position and said second tongue position.

13. The amphibious vehicle of claim 10, wherein said tongue is substantially aligned with said hull bottom when in said second tongue position, and is nearly transverse to said hull bottom when in said first tongue position.

14. The amphibious vehicle of claim 10, wherein said tongue is positioned near one end of said hull bottom, said one end being a front end of said vehicle when said wheel is in said first wheel position and said one end being a rear end of said vehicle when said wheel is in said second wheel position.

15. The amphibious vehicle of claim 1, including a plurality of hull sides extending upward from a perimeter of said hull bottom, at least one of said plurality of hull sides is pivotably connected to said hull bottom and can be rotatable to a position nearly aligned with said hull bottom.

16. An amphibious vehicle, comprising:
a trailer portion having a boating configuration and a towing configuration;
at least one wheel extending from said trailer portion, said at least one wheel supporting said trailer portion in said towing configuration for movement of said trailer portion on land; and
a hull portion of said trailer portion, said hull portion supporting said trailer portion in said boating configuration for movement of said trailer portion on water.

17. The amphibious vehicle of claim 16, wherein said at least one wheel is retractable to a position above said hull.

18. The amphibious vehicle of claim 16, including a tongue configured for attachment to another vehicle, said tongue is moveable between a first tongue position and a second tongue position further from said hull than said first tongue position, said first tongue position corresponding to said boating configuration and said second tongue position corresponding to said towing configuration.

19. A method of transporting cargo, comprising the steps of:
(a) towing cargo across land using a vehicle having a retractable wheel;
(b) retracting the wheel toward the vehicle; and
(c) moving the cargo across water using the vehicle.

20. The method of claim 19, including:
(d) using the wheel to facilitate placing the trailer into water before retracting the wheel and retracting the wheel before step (c).

21. The method of claim 19, including:
(d) moving a tongue between a second position for performing step (a) and a first position for performing step (b) before moving the cargo across water.
